(19) United States
(12) Patent Application Publication
(10) Pub. No.: US 2007/0088810 A1
(43) Pub. Date: Apr. 19, 2007

(54) Apparatus, system, and method for mapping a storage environment

(76) Inventors: Michael Loren Lamb, San Jose, CA (US); David Lynn Merbach, Rochester, MA (US); Kavita Manish Shah, San Jose, CA (US); Kevin Joseph Webster, Tigard, OR (US)

Correspondence Address: KUNZLER & ASSOCIATES, 8 EAST BROADWAY, SUITE 600, SALT LAKE CITY, UT, 84111, US

(21) Appl. No.: 11/253,767

(22) Filed: Oct. 19, 2005

(51) Int. Cl. G06F 15/173

(52) U.S. Cl. 709/223

(57) ABSTRACT

An apparatus, system, and method are disclosed for mapping a storage environment. An identification module identifies a first controller defined storage unit. A test module tests for a second controller defined storage unit corresponding to the first controller defined storage unit. In one embodiment, the second controller defined storage unit is a virtualized instance of the first controller defined storage unit. In an alternate embodiment, the first controller defined storage unit is a virtualized instance of the second controller defined storage unit. A flag module flags the first controller defined storage unit if there is a second controller defined storage unit corresponding to the first controller defined storage unit. In one embodiment, a monitor module monitors the status of each unflagged defined storage unit in the storage environment. In addition, a report module may report the status of each unflagged defined storage unit.

### BACKGROUND OF THE INVENTION

1. Field of the Invention

This invention relates to mapping storage environments and more particularly relates to mapping virtualized instances of storage environment elements.

2. Description of the Related Art

Data processing systems often employ a storage environment to store data. The storage environment may store and retrieve data for a plurality of data processing devices such as servers, mainframe computers, media delivery systems, communication systems, and the like. The storage environment may comprise one or more storage controller. Each storage controller may manage one or more storage devices or disks such as hard disk drives, optical storage drives, solid-state memory storage devices, and the like.

A data processing device such as a server may store data by communicating the data to the storage controller. The storage controller may write the data to a disk. Similarly, the data processing device may retrieve data by requesting the data from the storage controller. The storage controller may then read the data from the disk and communicate the data to the data processing device. In a certain embodiment, the disk comprises the storage controller.

Each disk may be divided into one or more logical partitions. In addition, one or more logical partitions from one or more disks may be logically aggregated to form a logical volume. A logical volume may appear to a data processing device as a single disk.

A storage environment may employ a storage virtualizing system (“SVS”) as an intermediary between the data processing device and the storage controller. The SVS may be a storage area network (“SAN”) volume controller or the like. In one embodiment, the SVS creates a virtual disk from one or many logical volumes of a storage controller. A data processing device may communicate with the virtual disk as though the virtual disk was a logical volume.

The SVS communicates requests to write data to the virtual disk and receive data from the virtual disk to the storage controller. The storage controller completes the write of data to a disk of the logical volume or completes retrieving data from the logical volume's disk. Thus the SVS appears as a storage controller to the data processing device, although data is stored on a disk of a storage controller, with the storage controller functioning as a back end device for the SVS.

The SVS may further comprise a managed disk. The managed disk may communicate with a storage controller logical volume. Data written to the SVS managed disk is communicated and written to the storage controller logical volume. In addition, data read from the SVS managed disk is retrieved from the storage controller logical volume and then communicated from the SVS. A data processing device may communicate with the SVS as though the SVS is a storage controller. In addition, the SVS creates virtual disks from the managed disks as though the managed disk is a disk.

A data processing system may store data through the SVS on one or more storage controllers, or may store data directly to one or more storage controllers. In addition, the data processing system may be unable to distinguish between storage environment elements such as logical volumes and disks, and virtualized instances of the storage environment elements, such as virtual disks and managed disks respectively. Hereinafter, storage environment elements such as logical volumes, virtual disks, disks, and managed disks are referred to as defined storage units (“DSU”).

Data processing systems often employ a storage monitoring application to report information about the storage environment. These applications may in-turn employ tools such as the IBM common information model/object manager (“CIM/OM”) to gather information about specific elements in the storage environment. For example, a CIM/OM may gather information on may gather information regarding the storage capacity of Storage Virtualizing Systems and Storage Subsystems. Storage monitoring applications obtain this information from the CIM/OM and then display reports showing the storage environment.

Unfortunately, in gathering information on the storage environment, the storage monitoring application may double count some storage environment DSUs. For example, a storage monitoring application may obtain information regarding a virtual disk of an SVS by collecting information regarding the SVS from the CIM/OM, and may also obtain information regarding the logical volumes of the storage controller associated with that virtual disk that are mapped to the SVS virtual disk. Then the storage monitoring application may generate an inaccurate report with the logical volume's storage status reported on as both that of the logical volume and as that of the virtual disk.

From the foregoing discussion, it should be apparent that a need exists for an apparatus, system, and method that maps DSUs to virtual DSUs in a storage environment. Beneficially, such an apparatus, system, and method would eliminate the double counting of storage environment DSUs and virtualized instances of the storage environment DSUs.

### SUMMARY OF THE INVENTION

The present invention has been developed in response to the present state of the art, and in particular, in response to the problems and needs in the art that have not yet been fully solved by currently available storage environment mapping methods. Accordingly, the present invention has been developed to provide an apparatus, system, and method for mapping a storage environment that overcome many or all of the above-discussed shortcomings in the art.

The apparatus to map a storage environment is provided with a logic unit containing a plurality of modules configured to functionally execute the necessary steps of identifying a first controller DSU, testing for a second controller DSU, and flagging the first controller DSU if there is a second controller DSU corresponding to the first controller DSU. These modules in the described embodiments include an identification module, a test module, and a flag module.

The identification module identifies a first controller DSU. In one embodiment, the first controller DSU is a logical volume and the first controller is configured as a storage controller. In an alternate embodiment, the first controller DSU is a managed disk and the first controller is a SVS backend controller.

The test module tests for a second controller DSU corresponding to the first controller DSU. For example, the test module may test for the existence of a logical volume assigned to a SVS node host bus adapter (“HBA”) world wide port name (“WWPN”). In an alternate example, the test module tests for existence of a storage controller WWPN corresponding to the SVS backend controller WWPN. As used herein, the term corresponding refers to elements associated by communication.

The flag module flags the first controller DSU if there is a second controller DSU corresponding to the first controller DSU. For example, the flag module may flag the logical volume if there exists a logical volume assigned to the SVS node HBA WWPN. In an alternate example, the flag module may flag a managed disk of the SVS backend controller if there exists a storage controller WWPN that corresponds to the SVS backend controller's WWPN. The apparatus maps the DSUs of a storage environment to corresponding virtualized DSUs.

A system of the present invention is also presented to map a storage environment. The system may be embodied in a data processing system. In particular, the system, in one embodiment, includes a storage environment and a data processing device. The storage environment includes a plurality of controllers. In one embodiment, the storage environment includes at least one storage controller and at least one SVS. The data processing device includes an identification module, a test module, and a flag module. In one embodiment, the data processing device further includes a monitor module and a report module.

The storage environment stores and retrieves data for the data processing system. In one embodiment, the SVS virtualizes the data storage functions of one or more storage controllers. For example, the SVS may virtualize a storage controller logical volume, making the logical volume available to the data processing system as a virtual disk. The virtual disk may be indistinguishable from a logical volume to the data processing system.

The identification module identifies a first controller DSU. The test module tests for a second controller DSU corresponding to the first controller DSU. The flag module flags the first controller DSU if there is a second controller DSU corresponding to the first controller DSU. Each flagged DSU has a corresponding DSU instance within the storage environment.

In one embodiment, the monitor module monitors the status of storage environment DSUs including unflagged DSUs while ignoring flagged DSUs. In addition, the report module may report the status of the storage environment DSUs including the unflagged DSUs while ignoring the flagged DSUs. The system supports the gathering and reporting of storage environment information by co-relating a DSU that is an instance of another DSU.

A method of the present invention is also presented for mapping a storage environment. The method in the disclosed embodiments substantially includes the steps necessary to carry out the functions presented above with respect to the operation of the described apparatus and system. In one embodiment, the method includes identifying a first controller DSU, testing for a second controller DSU, and flagging the first controller DSU if there is a second controller DSU corresponding to the first controller DSU.

An identification module identifies a first controller DSU. In addition, a test module tests for a second controller DSU corresponding to the first controller DSU. In one embodiment, the second controller DSU is a virtualized instance of the first controller DSU. In an alternate embodiment, the first controller DSU is a virtualized instance of the second controller DSU.

A flag module flags the first controller DSU if there is a second controller DSU corresponding to the first controller DSU. In one embodiment, a monitor module monitors the status of each unflagged DSU in the storage environment. In addition, a report module may report the status of each unflagged DSU. The method flags DSUs with corresponding DSUs, allowing the monitoring and reporting of DSU information without double counting of DSUs and DSU information.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention maps a DSU instance to a virtualized instance of the DSU, flagging one DSU instance. In addition, the embodiment of the present invention may support the monitoring and reporting of information for unflagged DSUs to prevent the double counting of DSU information. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a data processing system in accordance with the present invention;

FIG. 2 is a schematic block diagram illustrating one embodiment, of a storage controller in accordance with the present invention;

FIG. 3 is a schematic block diagram of a SVS in accordance with the present invention;

FIG. 4 is a schematic block diagram of a mapping apparatus of the present invention;

FIG. 5 is a schematic block diagram of data processing device in accordance with the present invention;

FIG. 6 is a schematic flow chart diagram illustrating one embodiment of a storage environment mapping method of the present invention;

FIG. 7 is a schematic flow chart diagram illustrating one embodiment of a storage controller mapping method of the present invention;

FIG. 8 is a schematic flow chart diagram illustrating one embodiment of a SVS mapping method of the present invention;

FIG. 9 is a schematic flow chart diagram illustrating one alternate embodiment of a SVS mapping method of the present invention;

FIG. 10 is a schematic block diagram illustrating one embodiment of a logical volume mapping of the present invention; and

FIG. 11 is a schematic block diagram illustrating one embodiment of a disk mapping of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment” “in an embodiment,” and similar language throughout this specification may, but do not necessarily, all refer to the same embodiment.

Reference to a signal-bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

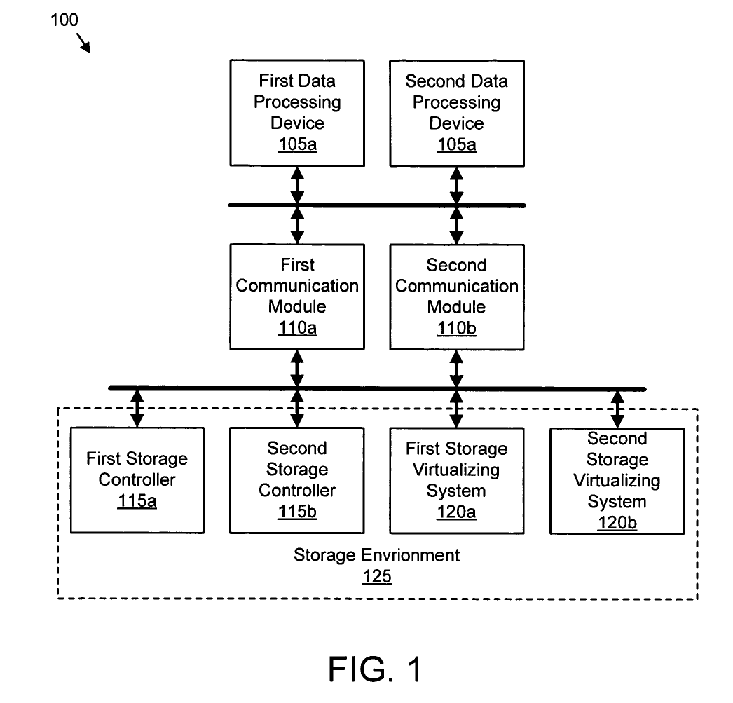

FIG. 1 is a schematic block diagram illustrating one embodiment of a data processing system 100 in accordance with the present invention. The system 100 includes one or more data processing devices (“DPD”) 105, one or more communication modules 110, one or more storage controllers 115, and one or more SVS 120. Although for simplicity the system 100 is depicted with two DPDs 105, two communications modules 110, two storage controllers 115, and two SVSs 120, any number of DPDs 105, communication modules 110, storage controllers 115, and SVSs 120 maybe employed. Additional devices may also be in communication with the system 100.

In one embodiment, the storage controllers 115 and SVSs 120 comprise a storage environment 125. The storage environment 125 stores and retrieves data for the data processing system 100. The DPD 105 executes one or more software processes. In addition, the DPD 105 may store data to and retrieve data from the storage environment 125.

The DPD 105 may communicate with the storage environment 125 through the communication module 110. The communication module 110 may be a router, a network interface, a storage manager, one or more Internet ports, or the like. The communication module 110 transfers communications between the DPD 105 and the storage environment 125.

The storage controller 115 stores and retrieves data within the storage environment 125. For example, the DPD 105 may write data to a first storage controller 115a and read data from a second storage controller 115b as is well known to those skilled in the art. Each storage controller 115 may comprise one or more disks.

In one embodiment, the SVS 120 virtualizes the data storage functions of one or more storage controllers 115. For example, a first SVS 120a may virtualize a first storage controller 115a logical volume, making the logical volume available to the data processing system 100 as a virtual disk. The virtual disk may be indistinguishable from the logical volume to the data processing system 100. In one embodiment, the first DPD 105 may request to read data from a virtual disk of the first SVS 120a. The second communication module 110b may transmit the request to the first SVS 120a. The first SVS 120a may retrieve the requested data from a logical volume of the first storage controller 115a corresponding to the virtual disk of the first SVS 120a. In an alternate example, the first SVS 120a may virtualize one or more logical volumes as a managed disk.

A DPD 105 such as the second DPD 105b may query the first SVS 120a for the capacity of the virtual disk through the first communication module 110a. The first SVS 120a queries a storage controller 115 comprising the logical volume such as the first storage controller 115 about the logical volume capacity, and reports the capacity as received from the first storage controller 115a to the second DPD 105b. The logical volume, virtual disk, disk, and managed disk of the storage environment 125 comprise DSU. In an alternate embodiment, a DPD 105 such as the second DPD 105b may query a proxy server of the SVS 120 or storage controller 115 for the capacity of the DSU. In a certain embodiment the proxy server may comprise a CIM/IOM.

Unfortunately, if the second DPD 105b also queried the first storage controller 115a for the capacity of the logical volume, the first storage controller 115a would respond again with the capacity of the logical volume. Thus a storage monitoring application software process executing on the DPD 105 may double count information from DSU such as the first storage controller 115a logical volume and the first SVS 120a virtual disk.

The embodiment of the present invention maps the storage environment 125, identifying and flagging DSU instances with corresponding DSU instances. In addition, the embodiment of the present invention may support monitoring and reporting on only unflagged DSU instances, preventing the double counting of DSU information.

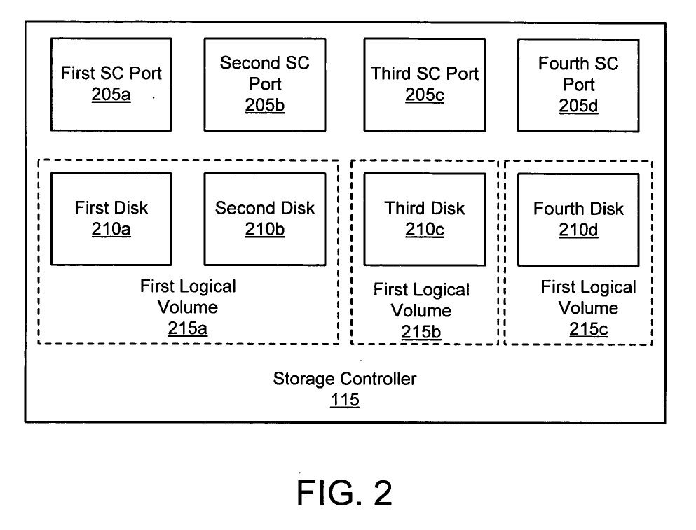

FIG. 2 is a schematic block diagram illustrating one embodiment, of a storage controller 115 in accordance with the present invention. The storage controller 115 is the storage controller 115 of FIG. 1. As depicted, the storage controller 115 includes one or more storage controller ports (“SC Ports”) 205, and one or more disks 210. The disks 210 are depicted aggregated into one or more logical volumes 215. A disk 210 may be a hard disk drive, an optical storage device, a magnetic tape drive, a electromechanical storage device, a semiconductor storage device, or the like.

Although for simplicity each logical volume 215 is depicted comprising an entire disk 210, each disk 210 may be partitioned into one or more logical partitions and each logical volume 215 may comprise one or more logical partitions from one or more disks 210. In addition, although the storage controller 115 is depicted with four SC ports 205, four disks 210, and three logical volumes 215, the storage controller 115 may employ any number of SC ports 205, disks 210, and logical volumes 215.

In one embodiment, the SC port 205 is configured as a Fibre Channel port. In an alternate embodiment, the SC port 205 is configured as a small computer system interface (“SCSI”) port, a token ring port, or the like. A DPD 105 or a SVS 120 such as the DPD 105 and SVS 120 of FIG. 1 may store data to and retrieve data from the disk 210 or the logical volume 215 by communicating with the disk 210 or logical volume through the SC port 205. Each Storage Controller 115 and SVS Port 320 may be identified by one or more WWPN. In one embodiment, a logical volume 215 is mapped to the WWPN of one or more SC ports 205.

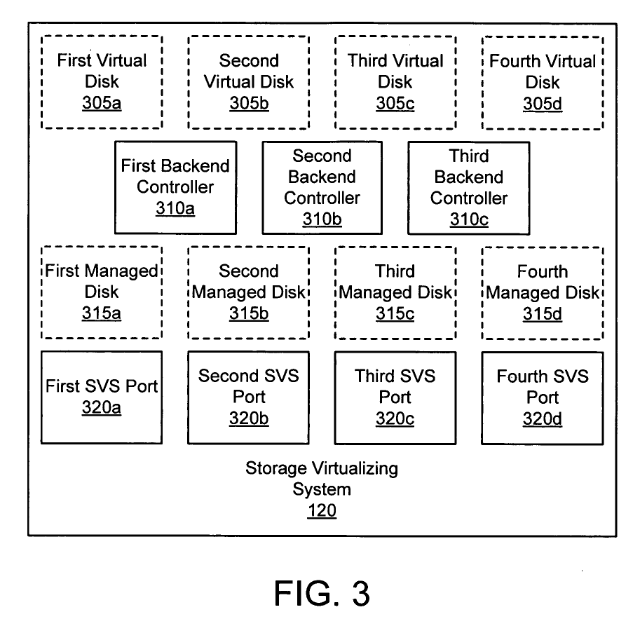

FIG. 3 is a schematic block diagram of a SVS 120 in accordance with the present invention. The SVS 120 is the SVS 120 of FIG. 1. As depicted, the SVS 120 includes one or more virtual disks 305, one or more backend controllers 310, one or more managed disks 315, and one or more SVS ports 320. Although for simplicity the SVS 120 is depicted with four virtual disks 305, three backend controllers 310, four managed disks 315, and four SVS ports 320, the SVS 120 may employ any number of virtual disks 305, backend controllers 310, managed disks 315, and SVS ports 320.

A DPD 105 such as the DPD 105 of FIG. 1 may communicate with the SVS 120, storing data to and retrieving data from the virtual disk 305. The virtual disk 305 is a virtual instance of a logical volume 215 of a storage controller 115 such as the storage controller 115 of FIGS. 1 and 2 and the logical volume 215 of FIG. 2. The virtual disk 305 does not physically store data. Instead, the virtual disk 305 is mapped to one or more managed disks 315. Each managed disk is mapped to a logical volume 215 of the storage controller 115. The backend controller 310 manages communication between the virtual disk 305 and the logical volume 215.

Data written to the virtual disk 305 is communicated from the backend controller 310 through a node. The node comprises an HBA, and the HBA is assigned a WWPN. The data is communicated from the node through the SVS port 320 and the SC port 205 of FIG. 2 to the logical volume 215. In one embodiment, the SVS port 320 is configured as a Fibre Channel port. The SVS port 320 may also be a token ring port, a SCSI port, or the like.

Similarly, data read from the virtual disk 305 is retrieved from the logical volume 215 through the SC port 205 and the SVS port 320 to the backend controller 310. The data may further be communicated from the backend controller 310 to the DPD 105. The virtual disk 305 appears to the DPD 105 as a logical volume 215.

In one embodiment, the managed disk 315 is a logical volume 215. The DPD 105 may write data to and read data from the managed disk 315. The managed disk 315 does not store data. Instead, a write to the managed disk 315 is communicated from the backend controller 310 through the SVS port 320 and SC port 205 to the logical volume 215 of the storage controller 215. Similarly, a request to read data from the managed disk 315 is communicated through the SVS port 320 and SC port 205 to the logical volume 215. The logical volume 215 communicates the data through the SC port 205 and SVS port 320 to the backend controller 310, and the backend controller 310 may communicate the retrieved data.

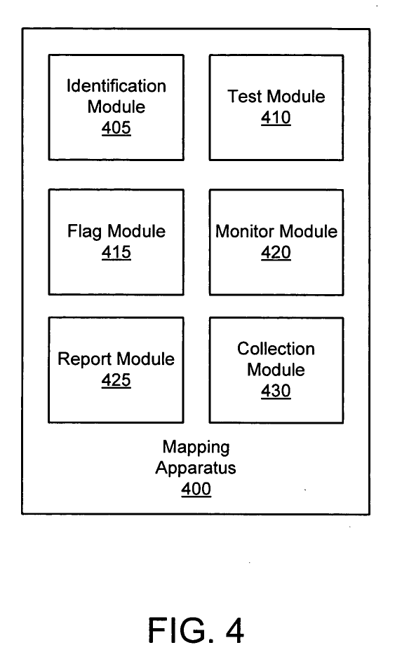

FIG. 4 is a schematic block diagram of a mapping apparatus 400 of the present invention. The apparatus 400 maybe comprised by a DPD 105 such as the DPD 105 of FIG. 1. In an alternate embodiment, the apparatus 400 may be comprised by a storage controller 115 or SVS 120 such as the storage controller 115 of FIGS. 1 and 2 and the SVS 120 of FIGS. 1 and 3. As depicted, the apparatus 400 includes an identification module 405, a test module 410, a flag module 415, a monitor module 420, a report module 425, and a collection module 430. The test module 410, flag module 415, monitor module 420, report module 425, and collection module 430 may be configured as one or more software processes. Elements referred to herein are the elements of FIGS. 1-3.

The identification module 405 identifies a first controller DSU. In one embodiment, the first controller DSU is a logical volume 215 and the first controller is configured as a storage controller 115. In an alternate embodiment, the first controller DSU is a managed disk 315 and the first controller is a backend controller 310.

The test module 410 tests for a second controller DSU corresponding to the first controller DSU. For example, the test module 410 may test for the existence of a logical volume 215 assigned to a SVS 120 node HBA WWPN. In an alternate example, the test module 410 tests for existence of a storage controller 115 WWPN corresponding to the backend controller 310 WWPN.

The flag module 415 flags the first controller DSU if there is a second controller DSU corresponding to the first controller DSU. For example, the flag module 415 may flag the logical volume 215 if there exists a logical volume 215 assigned to the SVS 120 node HBA WWPN. In an alternate example, the flag module 415 may flag a managed disk 315 of the backend controller 310 if there exists a storage controller 115 WWPN that corresponds to the backend controller's 310 WWPN.

In an alternate embodiment, the identification module 405 identifies a query to a first controller DSU. The identification module 405 may be comprised by the first controller. The test module 410 may test for the existence of a second controller DSU corresponding to the first controller DSU. The flag module 415 flags the first controller DSU if there is a second controller DSU corresponding to the first controller DSU. In one embodiment, the first controller does not respond to the query if the first controller DSU is flagged.

In one embodiment, the collection module 430 is configured to collect a plurality of logical volume assignments to WWPN for each of the storage controller 115 logical volumes 215. The collection module 430 may poll each logical volume 215 for the logical volume's 215 WWPN assignment. Alternatively, the collection module 430 may consult a configuration file for the WWPN assignment of each logical volume 215.

In one embodiment, the monitor module 420 monitors the status of unflagged DSUs in the storage environment 125 while ignoring flagged DSUs. For example, if the first logical volume 215a of FIG. 2 is flagged but the second and third logical volumes 215a, 215b of FIG. 2 are unflagged, the monitor module 420 may monitor the second and third logical volumes 215a, 215b and the virtual disks 305 of FIG. 3, but not monitor the flagged first logical volume 215a.

The report module 425 may report the status of the unflagged DSUs in the storage environment 125 while ignoring the flagged DSUs. For example, if the first managed disk 315a of FIG. 3 is flagged but the second, third and fourth managed disks 315b-d of FIG. 3 are not flagged, the report module 425 may report the status of the second, third and fourth managed disks 315b-d and the disks 210 of FIG. 2, but not report the status of the first managed disk 315a. The apparatus 400 maps the DSUs of the storage environment 125 to corresponding virtual DSUs.

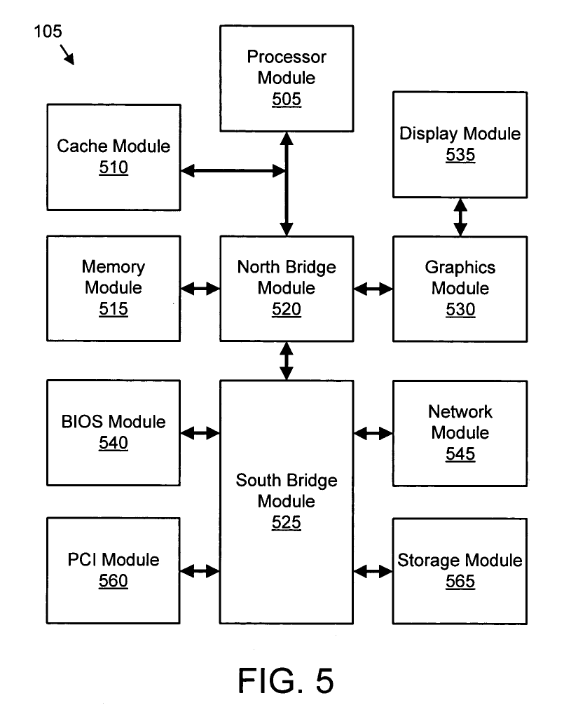

FIG. 5 is a schematic block diagram of DPD 105 in accordance with the present invention. The DPD 105 includes a processor module 505, a cache module 510, a memory module 515, a north bridge module 520, a south bridge module 525, a graphics module 530, a display module 535, a basic input/output system (“BIOS”) module 540, a network module 545, a peripheral component interconnect (“PCI”) module 560, and a storage module 565. The DPD 105 may process data as is well known to those skilled in the art. In one embodiment, the DPD 105 is the DPD 105 of FIG. 1.

The processor module 505, cache module 510, memory module 515, north bridge module 520, south bridge module 525, graphics module 530, display module 535, BIOS module 540, network module 545, PCI module 560, and storage module 565, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate to substrate wiring, or circuit card traces or wires connecting the semiconductor devices.

The memory module 515 stores software instructions and data. The processor module 505 executes the software instructions and manipulates the data as is well know to those skilled in the art. In one embodiment, the test module 410, flag module 415, monitor module 420, report module 425, and collection module 430 of FIG. 4 comprise one or more software processes executing on the processor module 505. In addition, the test module 410, flag module 415, monitor module 420, report module 425, and collection module 430 may communicate with the SVS 120 of FIGS. 1 and 3, and the storage controller 115 of FIGS. 1 and 2 as the processor module 505 communicates through the north bridge 520, south bridge 525, and network module 545 with the communication module 110 of FIG. 1. The network module 545 may be configured as an Ethernet interface, a token ring interface, or the like.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

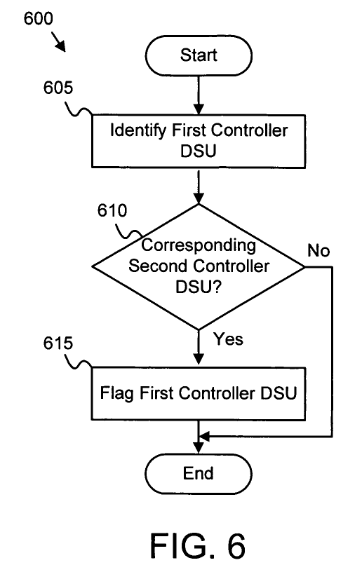

FIG. 6 is a schematic flow chart diagram illustrating one embodiment of a storage environment mapping method 600 of the present invention. The method 600 substantially includes the steps necessary to carry out the functions presented above with respect to the operation of the described apparatus 200, 300, 400, 500 and system 100 of FIGS. 1-5. The elements referenced are the elements of FIGS. 1-5.

The method 600 begins and an identification module 405 identifies 605 a first controller DSU. In one embodiment, the first controller DSU is a logical volume 215 and the first controller is a storage controller 115. In an alternate embodiment, the first controller DSU is a disk 210 and the first controller is a storage controller 115.

A test module 410 tests 610 for a second controller DSU corresponding to the first controller DSU. In one embodiment, the second controller DSU is a virtualized instance of the first controller DSU. For example, if the first controller is the storage controller 115 and the first controller DSU is the logical volume 215, the second controller may be a SVS 120 and the second controller DSU may be a virtual disk 305. In an alternate embodiment, the first controller DSU is a virtualized instance of the second controller DSU. For example, if the first controller is the backend controller 310 and the first controller DSU is the managed disk 315, the second controller may be the storage controller 115 and the second controller DSU may also be configured as the storage controller 115.

If the test module 410 determines 610 that there exists a second controller DSU corresponding to the first controller DSU, a flag module 415 flags 615 the first controller DSU and the method 600 terminates. Flagging 615 the first controller DSU indicates that there is another instance of the first controller DSU, or several instances that make up the first controller DSU, that maybe monitored and reported on. Therefore, the first controller DSU may be ignored during monitoring or reporting operations when monitoring and reporting on the storage environment 125 as the first controller DSU information is acquired from the corresponding second controller DSU.

If the test module 410 determines 610 that there is no second controller DSU corresponding to the first controller DSU, the method 600 terminates without flagging the first controller DSU. Not flagging the first controller DSU indicates that there is no other instance of the first controller DSU. Therefore the first controller DSU should be monitored and reported on when monitoring and reporting on the storage environment 125. The method 600 flags the first controller DSU that is an instance of the second controller DSU, allowing only a single instance to be monitored and reported on.

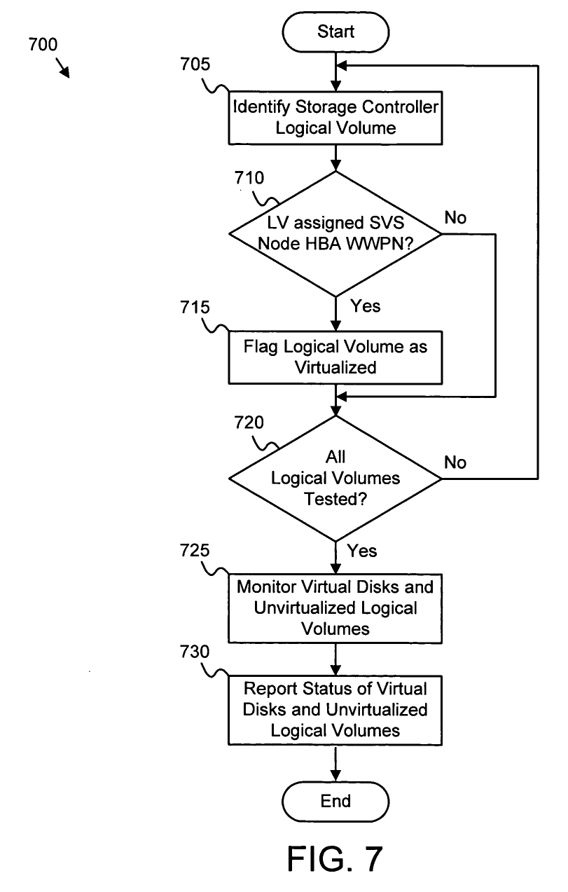

FIG. 7 is a schematic flow chart diagram illustrating one embodiment of a storage controller mapping method 700 of the present invention. The method 700 substantially includes the steps necessary to carry out the functions presented above with respect to the operation of the described apparatus 200, 300, 400, 500, system 100, and method 600 of FIGS. 1-6. The elements referenced are the elements of FIGS. 1-5.

The method 700 begins and an identification module 405 identifies 705 a logical volume 215 of a storage controller 115. In one embodiment, the identification module 405 identifies 705 the logical volume 215 by querying the storage controller 115 for all logical volumes 215 managed by the storage controller 115 and by selecting a logical volume 215 from the plurality of logical volumes 215. The selected logical volume 215 may be previously unselected by the identification module 405.

A test module 410 tests 710 if there exists a logical volume 215 assigned to a SVS 120 node HBA WWPN. If a logical volume 215 is assigned to the SVS 120 node HBA WWPN, a flag module 415 flags 715 the logical volume 215 and the test module 410 determines 720 if all storage controller 115 logical volumes 215 have been tested. In one embodiment, the flag module 415 flags 715 the logical volume 215 as virtualized. If there is no logical volume 215 assigned to the SVS 120 node HBA WWPN, the test module 410 determines 720 if all storage controller 115 logical volumes 215 have been tested. In one embodiment, the test module 410 determines 720 if all logical volumes 215 of a plurality of storage controllers 115 have been tested.

If the test module 410 determines 720 that not all storage controller 115 logical volumes 215 have been tested, the method 700 loops to the identification module 405 identifying 705 a logical volume 215. If the test module 410 determines 720 that all storage controller 115 logical volumes 215 have been tested, a monitor module 420 may monitor 725 all virtual disks 305 and unflagged logical volumes 215 in a storage environment 125. For example, the monitor module 420 may gather information on the virtual disks 305 and unflagged logical volumes 215.

In one embodiment, a report module 425 reports 730 the status of the virtual disks 305 and unflagged logical volumes 215 in the storage environment 125, while not reporting the status of the flagged logical volumes 215, and the method 700 terminates. By not reporting the status of the flagged logical volumes 215, the report module 425 avoids double reporting the status of both the flagged logical volume 215 and the virtual disk 305 that corresponds to the flagged logical volume 215.

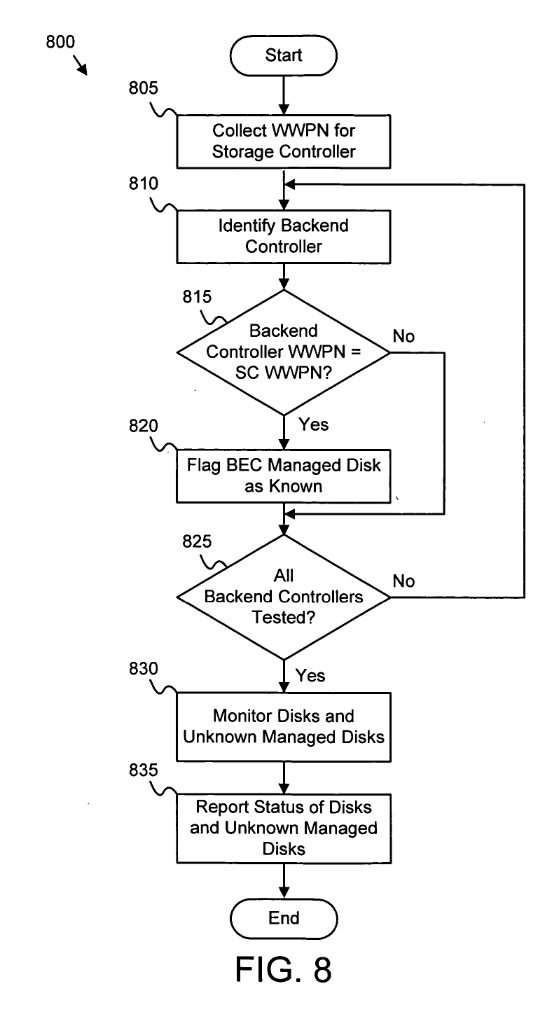

FIG. 8 is a schematic flow chart diagram illustrating one embodiment of a SVS mapping method 800 of the present invention. The method 800 substantially includes the steps necessary to carry out the functions presented above with respect to the operation of the described apparatus 200, 300,400, 500, system 100, and method 600 of FIGS. 1-6. The elements referenced are the elements of FIGS. 1-5.

The method 800 begins and in one embodiment, a collection module 430 collects 805 the WWPN for one or more storage controllers 115. In a certain embodiment, the collection module 430 queries the storage controller 115 for the WWPN, and the storage controller 115 communicates the WWPN to the collection module 430.

An identification module 405 identifies 810 a backend controller 310 of a SVS 120. In one embodiment, the identification module 405 identifies 810 the backend controller 310 by querying the SVS 120 for all backend controllers 310 comprised by the SVS 120 and by selecting a backend controller 310 from the plurality of backend controllers 310. In an alternate embodiment, the SVS 120 has a known number of backend modules 310 and the identification module 405 identifies 810 and selects each backend module 310 in turn. The selected backend controller 310 may be previously unselected by the identification module 405.

A test module 410 tests 815 if there exists a storage controller 115 WWPN that corresponds to the backend controller 310 WWPN. If there exists a storage controller 115 WWPN from the collected 805 WWPN that corresponds to the backend controller 310 WWPN, a flag module 415 flags 820 a managed disk 315. The managed disk 315 is controlled by the backend controller 310 and communicates with a storage controller 115 using the backend controller 310 port, which has a unique WWPN. In one embodiment, the flag module 415 flags 820 the managed disk 315 as known.

If there is no a storage controller 115 WWPN from the collected 805 WWPN that corresponds to the backend controller 310 WWPN, the test module 410 determines 825 if all backend controllers 310 have been tested. In one embodiment, the test module 410 determines 825 if all backend controllers 310 of a plurality of SVS 120 have been tested.

If the test module 410 determines 825 that not all backend controllers 310 have been tested, the method 800 loops to the identification module 405 identifying 810 a backend controller 310. If the test module 410 determines 825 that all backend controllers 310 have been tested, a monitor module 420 may monitor 830 all disks 210 and unflagged managed disks 315 in a storage environment 125. For example, the monitor module 420 may gather information on the disks 210 and unflagged managed disks 315.

In one embodiment, a report module 425 reports 835 the status of the disks 210 and unflagged managed disks 315 in the storage environment 125, while not reporting the status of the flagged managed disks 315, and the method 800 terminates. By not reporting the status of the flagged managed disk 315, the report module 425 avoids double reporting the status of both the flagged managed disk 315 and the disk 210 that corresponds to the managed disk 315.

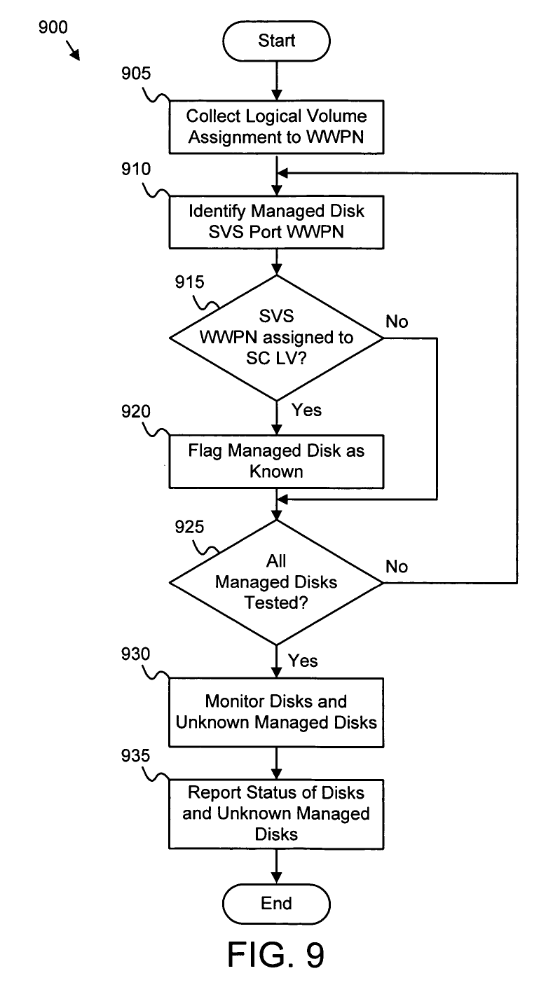

FIG. 9 is a schematic flow chart diagram illustrating one alternate embodiment of a SVS mapping method 900 of the present invention. The method 900 substantially includes the steps necessary to carry out the functions presented above with respect to the operation of the described apparatus 200, 300, 400, 500, system 100, and method 600 of FIGS. 1-6. The elements referenced are the elements of FIGS. 1-5.

The method 900 begins and in one embodiment, a collection module 430 collects 905 logical volume 215 assignments to WWPN for one or more logical volumes 215 of one or more storage controllers 115. In a certain embodiment, the collection module 430 queries the storage controller 115 for the WWPN assignment of each logical volume 215, and the storage controller 115 communicates the assignments to the collection module 430.

An identification module 405 identifies 910 the SVS port 320 for a managed disk 315. In one embodiment, the identification module 405 queries the SVS 120 to identify each SVS 120 managed disk 315, selects a managed disk 315, and queries the SVS 120 for the managed disk's 315 SVS port 320 WWPN. The selected managed disk 315 SVS port 320 may be previously unselected by the identification module 405.

A test module 410 tests 915 whether there exists a SVS port 320 WWPN assigned to a storage controller 115 logical volume 215. If there exists a SVS port 320 WWPN assigned to the storage controller 115 logical volume 215, a flag module 415 flags 920 the managed disk 315. In one embodiment, the flag module 415 flags 820 the managed disk 315 as known.

If there is no a SVS port 320 WWPN assigned to the storage controller 115 logical volume 215, the test module 410 determines 925 if all managed disks 315 have been tested. In one embodiment, the test module 410 determines 925 if all managed disks 315 of a plurality of SVS 120 have been tested.

If the test module 410 determines 925 that not all managed disks 315 have been tested, the method 900 loops to the identification module 405 identifying 910 a SVS port 320. If the test module 410 determines 925 that all managed disks 315 have been tested, a monitor module 420 may monitor 930 all disks 210 and unflagged managed disks 315 in the storage environment 125.

In one embodiment, a report module 425 reports 930 the status of the disks 210 and unflagged managed disks 315 in the storage environment 125, while not reporting the status of the flagged managed disks 315, and the method 900 terminates.

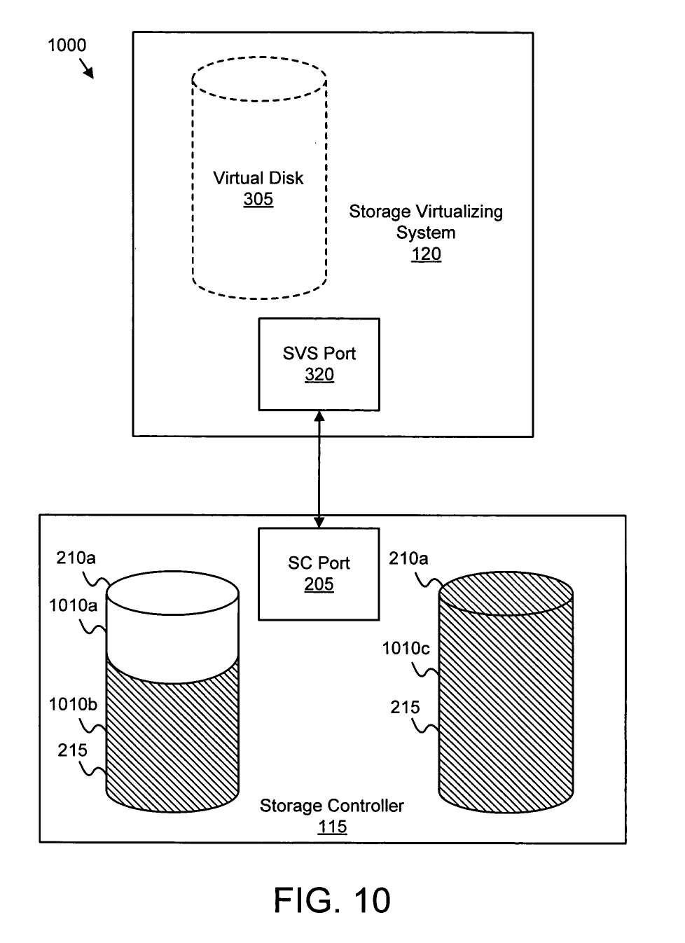

FIG. 10 is a schematic block diagram illustrating one embodiment of a logical volume mapping 1000 of the present invention. A storage controller 115 such as the storage controller 115 of FIGS. 1 and 2 comprises two disks 210, such as the disks 210 of FIG. 2. A first disk 210a is divided into first and second logical partitions 1010a, 1010b. A second disk 210b comprises a single third logical partition 110c. The second and third logical partitions 1010b, 1010c are aggregated as a logical volume 215, as shown by the cross hatching.

A SVS 120 virtualizes the logical volume 215 as a managed disk 315. The SVS 120 presents a set of managed disks 315 as a virtual disk 305. The virtual disk 305 communicates with the logical volume 215 through a SVS port 320 and a SC port 205 such as the SVS port 320 of FIG. 3 and the SC port 205 of FIG. 2. If the logical volume 215 is flagged 715, such as by the method 700 of FIG. 7, only the virtual disk 305 is monitored 725 and reported on 730, preventing the double counting of the logical volume 215 and the virtual disk 305.

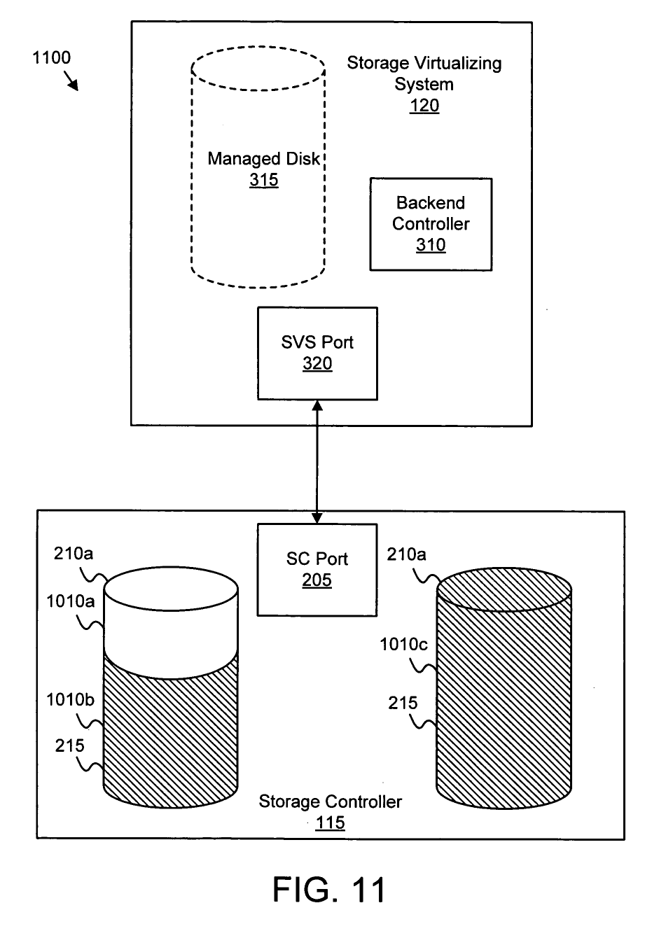

FIG. 11 is a schematic block diagram illustrating one embodiment of a disk mapping 1100 of the present invention. A storage controller 115 such as the storage controller 115 of FIGS. 1, 2, and 10 is configured with two disks 210 such as the disks of FIGS. 2 and 10. The disks 210 comprise a logical volume 215. A SVS 120 such as the SVS 120 of FIGS. 1, 3, and 10 comprises a backend controller 310 such as the backend controller 310 of FIGS. 3 and 10. The backend controller 310 virtualizes the logical volume 215 as a managed disk 315 such as the managed disk 315 of FIG. 3. The backend controller 310 writes data written to the managed disk 315 through a SVS port 320 and a SC port 205 such as the SVS port 320 of FIGS. 3 and 10 and the SC port 205 of FIGS. 2 and 10 to the logical volume 215 residing on the disks 210. Similarly, the backend controller 310 communicates data read from the logical volume 215 when a DPD 105 such as the DPD 105 reads data from the managed disk 315.

Thus the managed disk 315 virtualizes the logical volume 215. If the managed disk 315 is flagged 820, 920, such as by method 800 or method 900 of FIGS. 8 and 9, only the first and second disks 210a, 210b are monitored 830, 930 and reported on 835, 935. Ignoring the managed disk 315 prevents the managed disk 315 and the first disk and second disk 210a from being double counted.

The embodiment of the present invention maps a DSU instance to a virtualized instance of the DSU, flagging one DSU instance. In addition, the embodiment of the present invention may support the monitoring and reporting of information for unflagged DSUs to prevent the double counting of DSU information.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to map a storage environment, the apparatus comprising:
an identification module configured to identify a first controller DSU;
a test module configured to test for a second controller DSU corresponding to the first controller DSU; and
a flag module configured to flag the first controller DSU if there is a second controller DSU corresponding to the first controller DSU.

2. The apparatus of claim 1, further comprising a monitor module configured to monitor the status of each unflagged DSU.

3. The apparatus of claim 1, further comprising a report module configured to report the status of each unflagged DSU.

4. The apparatus of claim 1, wherein the first controller is configured as a storage controller, the first controller DSU is configured as a logical volume, the second controller is configured as a storage virtualizing system, and the second controller DSU is configured as a virtual disk.

5. The apparatus of claim 4, wherein the test for the second controller DSU corresponding to the first controller DSU is the existence of a logical volume assigned to a storage virtualizing system node HBA WWPN.

6. The apparatus of claim 1, wherein the first controller is configured as a storage virtualizing system backend controller, the first controller DSU is configured as a managed disk, the second controller is configured as a storage controller, and the second controller DSU is configured as the storage controller.

7. The apparatus of claim 6, further comprising a collection module configured to collect a plurality of storage controller logical volume assignments to WWPN and wherein the test for the second controller DSU corresponding to the first controller DSU is the existence of a storage controller WWPN corresponding to a storage virtualizing system backend controller WWPN.

8. The apparatus of claim 6, wherein the second controller DSU is configured as a logical volume, the apparatus further comprising a collection module configured to collect a WWPN for a plurality of the storage controller logical volumes, and wherein the test for the second controller DSU corresponding to the first controller DSU is the existence of a storage virtualizing system WWPN assigned to a storage controller logical volume.

9. An apparatus to detect redundant queries, the apparatus comprising:
an identification module configured to identify a query to a first controller DSU;
a test module configured to test for a second controller DSU corresponding to the first controller DSU; and
a flag module configured to flag the first controller DSU if there is a second controller DSU corresponding to the first controller DSU.

10. A system to map a storage environment, the system comprising:
a storage environment configured to store data and comprising a first and second controller;
a data processing device comprising
an identification module configured to identify a first controller DSU;
a test module configured to test for a second controller DSU corresponding to the first controller DSU; and
a flag module configured to flag the first controller DSU if there is a second controller DSU corresponding to the first controller DSU.

11. The system of claim 10, wherein the first controller is configured as a storage controller, the first controller DSU is configured as a logical volume, the second controller is configured as a storage virtualizing system, and the second controller DSU is configured as a virtual disk, and wherein the test for the second controller DSU corresponding to the first controller DSU is the existence of a logical volume assigned to a storage virtualizing system node HBA WWPN.

12. The system of claim 10, wherein the first controller is configured as a storage virtualizing system backend controller, the first controller DSU is configured as a managed disk, the second controller is configured as a storage controller, and the second controller DSU is configured as the storage controller, further comprising a collection module configured to collect a plurality of storage controller logical volume assignments to WWPN, and wherein the test for the second controller DSU corresponding to the first controller DSU is the existence of a storage controller WWPN corresponding to a storage virtualizing system backend controller WWPN.

13. The system of claim 10, wherein the first controller is configured as a storage virtualizing system backend controller, the first controller DSU is configured as a managed disk, the second controller is configured as a storage controller, and the second controller DSU is configured as the storage controller, the system further comprising a collection module configured to collect the WWPN for a plurality of the storage controller logical volumes, and wherein the test for the second controller DSU corresponding to the first controller DSU is the existence of a storage virtualizing system WWPN assigned to a storage controller logical volume.

14. The system of claim 10, the storage environment further comprising a disk.

15. The system of claim 10, wherein the storage virtualizing system is configured as a storage area network virtual controller.

16. A signal bearing medium tangibly embodying a program of machine-readable instructions executable by a digital processing apparatus to perform an operation to map a storage environment, the operation comprising:
identifying a first controller DSU;
testing for a second controller DSU corresponding to the first controller DSU; and
flagging the first controller DSU if there is a second controller DSU corresponding to the first controller DSU.

17. The signal bearing medium of claim 16, wherein the instructions further comprise an operation to monitor the status of each unflagged DSU.

18. The signal bearing medium of claim 16, wherein the instructions further comprise an operation to report the status of each unflagged DSU.

19. The signal bearing medium of claim 16, wherein the first controller is configured as a storage controller, the first controller DSU is configured as a logical volume, the second controller is configured as a storage virtualizing system, and the second controller DSU is configured as a virtual disk.

20. The signal bearing medium of claim 16, wherein the test for the second controller DSU corresponding to the first controller DSU is the existence of a logical volume assigned to a storage virtualizing system node HBA WWPN.

21. The signal bearing medium of claim 16, wherein the first controller is configured as a storage virtualizing system backend controller, the first controller DSU is configured as a managed disk, the second controller is configured as a storage controller, and the second controller DSU is configured as the storage controller.

22. The signal bearing medium of claim 21, wherein the instructions further comprise an operation to collect a plurality of WWPN and wherein the test for the second controller DSU corresponding to the first controller DSU is the existence of a storage controller WWPN corresponding to a storage virtualizing system backend controller WWPN.

23. The signal bearing medium of claim 21, wherein the second controller DSU is configured as a logical volume, wherein the instructions further comprise an operation to collect the WWPN that are assigned access to a plurality of the storage controller logical volumes, and wherein the test for the second controller DSU corresponding to the first controller DSU is the existence of a storage virtualizing system WWPN assigned to a storage controller logical volume.

24. A method for deploying computer infrastructure, comprising integrating computer-readable code into a computing system, wherein the code in combination with the computing system is capable of performing the following:
identifying a first controller DSU;
testing for a second controller DSU corresponding to the first controller DSU; and
flagging the first controller DSU if there is a second controller DSU corresponding to the first controller DSU.

25. The method of claim 24, wherein the first controller is configured as a storage controller, the first controller DSU is configured as a logical volume, the second controller is configured as a storage virtualizing system, and the second controller DSU is configured as a virtual disk.

26. The method of claim 25, wherein the test for the second controller DSU corresponding to the first controller DSU is the existence of a logical volume assigned to storage virtualizing system node HBA WWPN.

27. The method of claim 24, wherein the first controller is configured as a storage virtualizing system backend controller, the first controller DSU is configured as a managed disk, the second controller is configured as a storage controller, and the second controller DSU is configured as the storage controller.

28. The method of claim 27, further comprising collecting a plurality of WWPNs and wherein the test for the second controller DSU corresponding to the first controller DSU is the existence of a storage controller WWPN corresponding to a storage virtualizing system backend controller WWPN.

29. The method of claim 27, wherein the second controller DSU is configured as a logical volume, further comprising collecting the WWPN for a plurality of the storage controller logical volumes, and wherein the test for the second controller DSU corresponding to the first controller DSU is the existence of a storage virtualizing system WWPN assigned to a storage controller logical volume.
